(19) United States
(12) Patent Application Publication
(10) Pub. No.: US 2026/0227346 A1
(43) Pub. Date: Aug. 6, 2026

(54) RADIATION CT DEVICE AND RADIATION CT SYSTEM

(71) Applicant: Comscantecno Co., Ltd., Yokohama-shi (JP)

(72) Inventor: Yasukazu TANAKA, Yokohama-shi (JP)

(21) Appl. No.: 19/464,703

(22) Filed: Jan. 30, 2026

(30) Foreign Application Priority Data
Jan. 31, 2025 (JP) 2025-015561

(51) Int. Cl. G01N 23/046; G01N 23/083; G06T 12/20; G06T 12/30

(52) U.S. Cl. CPC G01N 23/046; G01N 23/083; G06T 12/20; G06T 12/30; G01N 2223/401; G01N 2223/643; G06T 2211/436

(57) ABSTRACT

A radiation CT device includes a radiation source that emits radiation that spreads three-dimensionally along an optical axis direction; a radiation detector in the form of a two-dimensional array; a moving device that passes a subject through a cone beam of the radiation that spreads three-dimensionally; a cone-beam projection data collector that collects cone-beam projection data, which is acquired by projecting the cone-beam radiation onto the radiation detector, at respective positions in the movement direction; and a reconstructor that reconstructs a tomographic image based on the collected cone-beam projection data.

### TECHNICAL FIELD

The present teaching relates to a radiation CT device and a radiation CT system configured to acquire a tomographic image of a subject by irradiating the subject with radiation.

### BACKGROUND ART

There has been known a radiation CT (Computed Tomography) device that reconstructs a tomographic image of a subject based on projection data acquired by irradiating the subject with radiation using a radiation source that emits the radiation as a fan beam or a cone beam. In such a radiation CT device, in particular, a method using X-rays as the radiation is referred to as X-ray CT technology.

As methods for imaging a subject using X-rays, there is a method in which the subject is rotated relative to an X-ray source and a detector during imaging, and a method in which the subject is passed between the X-ray source and the detector by translational movement in one direction during imaging. For example, Patent Literature 1 discloses a radiation tomographic imaging device that reconstructs a tomographic image based on radiation equivalent data acquired by projecting radiation while changing projection direction angles of a radiation source to a subject conveyed in one direction along a conveyance path.

Manufacturing lines for industrial products occasionally involves inspection using X-rays. In such manufacturing lines, products are often conveyed linearly in one direction by a belt conveyor or the like. In an imaging method in which a subject is rotated relative to an X-ray source and a detector, the product is placed on a turntable or the like. Therefore, in such an imaging method, it is necessary to stop conveyance of the product in the manufacturing line while the turntable or the like is rotating, and thus the conveyance efficiency decreases. For this reason, when performing inspection using X-rays in a manufacturing line for industrial products, the above-described imaging method using translational movement in one direction is more suitable in terms of efficiency than the above-described imaging method involving rotation.

### CITATION LIST

### Patent Literature

Patent Literature 1: Japanese Unexamined Patent Application Publication No. S60-073443

### SUMMARY OF INVENTION

### Technical Problem

Meanwhile, in a manufacturing line for industrial products, since the product as the subject is conveyed in one direction, it may not be possible to collect projection data over 360°. Further, in the radiation tomographic imaging device of Patent Literature 1, the X-ray tube and the detector are rotated from 180° to 360° around an axis extending in the conveyance direction. Therefore, in the radiation tomographic imaging device of Patent Literature 1, a rotation space for the X-ray tube and the detector is required. Accordingly, a configuration that allows further space saving is required for radiation CT devices.

The object of the present teaching is to provide a radiation CT device that allows further space saving while enabling collection of projection data in a given angle range of a subject that is continuously conveyed in one direction, thereby reconstructing it as three-dimensional data in which tomographic images are stacked.

### Solution to Problem

A radiation CT device according to a first aspect of the present teaching is configured to reconstruct a tomographic image based on projection data acquired by irradiating a subject with radiation. The radiation CT device includes a radiation source configured to emit cone-beam radiation that spreads three-dimensionally along an optical axis direction, a radiation detector positioned on one side of the optical axis direction with respect to the radiation source, the radiation detector having channels for detecting the radiation, the channels being arranged in a two-dimensional array, a moving device configured to pass the subject through the radiation by moving the subject relative to the radiation source and the radiation detector in a movement direction intersecting the optical axis direction, a cone-beam projection data collector configured to collect cone-beam projection data in the form of a cone beam, which is acquired by projecting the cone-beam radiation onto the radiation detector, at respective positions in the movement direction, by detecting, with the radiation detector, the radiation emitted from the radiation source onto the subject that is relatively moved in the movement direction by the moving device, and a reconstructor configured to reconstruct a tomographic image or three-dimensional data based on the collected cone-beam projection data.

In the configuration described above, the cone-beam projection data collector collects the cone-beam projection data as a cone beam of the subject at each position in the movement direction. Specifically, in the above configuration, the subject is imaged by being relatively moved in the movement direction, rather than being rotated in place. This allows sequential imaging of a plurality of subjects arranged in a line in the movement direction.

Accordingly, the above configuration allows further space saving while enabling collection of projection data in a given angle range of a subject that is continuously conveyed in one direction, thereby reconstructing it as three-dimensional data in which tomographic images are stacked.

A radiation CT device according to a second aspect of the present teaching is configured such that, in addition to the first aspect, the reconstructor includes a parallel-beam projection data converter configured to acquire parallel-beam projection data corresponding to projection of a parallel beam through the subject, based on the collected cone-beam projection data, and the reconstructor reconstructs a tomographic image based on the parallel-beam projection data.

According to the above configuration, the parallel-beam projection data converter converts the cone-beam projection data into the parallel-beam projection data in a parallel-beam format, which corresponds to projection of a parallel beam through the subject, by changing the reading method of the cone-beam projection data. In this way, the reconstructor is capable of reconstructing the tomographic image by way of a back-projection method for parallel beams.

A radiation CT device according to a third aspect of the present teaching is configured such that, in addition to the first aspect, the reconstructor includes a reconstruction function convolution section configured to suppress artifacts occurring in the tomographic image when a radiation angle range of the radiation source over which the parallel-beam projection data is acquired is less than 180°.

When the tomographic image is reconstructed based on the parallel-beam projection data that is acquired over a radiation angle range of the radiation source that is less than 180°, artifacts (false images) may occur. By adjusting the frequency components of the reconstruction function so as to mitigate such artifacts, false images can be suppressed to some extent.

In the above configuration with the reconstruction function convolution section that suppresses the artifacts as described above, a tomographic image or three-dimensional data that is visually easier to recognize or easier to evaluate during image processing can be reconstructed.

A radiation CT device according to a fourth aspect of the present teaching further includes, in addition to the first aspect, a measurer configured to measure a dimension of a target object in the tomographic image, and a determiner configured to determine whether the dimension is within a predetermined range.

According to the above configuration, for example, the results indicating “Pass” or “Fail” for the target object can be determined based on the determination criteria for dimensional specifications of the manufactured target objects.

A radiation CT system according to a fifth aspect of the present teaching includes a plurality of projection-data collectors configured to collect projection data acquired by irradiating a subject with radiation, and a reconstructor configured to reconstruct a tomographic image based on the projection data collected by the projection-data collectors. Each of the plurality of projection-data collectors includes: a radiation source configured to emit cone-beam radiation that spreads three-dimensionally along an optical axis direction; a radiation detector positioned on one side of the optical axis direction with respect to the radiation source, the radiation detector having channels for detecting the radiation, the channels being arranged in a two-dimensional array; a moving device configured to pass the subject through the radiation by moving the subject relative to the radiation source and the radiation detector in a movement direction intersecting the optical axis direction; and an imaging controller configured to collect cone-beam projection data, which is acquired by projecting the cone-beam radiation onto the radiation detector, at respective positions in the movement direction, by detecting, with the radiation detector, the radiation emitted from the radiation source onto the subject that is relatively moved in the movement direction by the moving device. The imaging controller of each of the plurality of projection-data collectors performs imaging of the subject while changing a relative angle of the subject with respect to the radiation source and the radiation detector so that projection angles with respect to the subject correspond to continuous imaging directions, thereby collecting the cone-beam projection data such that a total angle range in the movement direction of the radiation source becomes 180° or more. The reconstructor reconstructs a tomographic image or three-dimensional data based on the cone-beam projection data collected at each of the relative angles of the subject.

According to the above configuration, reconstruction processing can be performed based on the cone-beam projection data sequentially collected by the plurality of projection-data collectors while changing the relative angle of the subject, and a tomographic image with further reduced artifacts can be acquired.

A radiation CT system according to a sixth aspect of the present teaching includes, in addition to the fifth aspect, an inter-device conveyance device configured to convey the subject from a terminal end of the moving device of an N-th projection-data collector in the plurality of projection-data collectors to a starting end of the moving device of an (N+1)-th projection-data collector in the plurality of projection-data collectors. The inter-device conveyance device conveys the subject conveyed from the terminal end of the moving device of the N-th projection-data collector to the starting end of the moving device of the (N+1)-th projection-data collector in a state where the subject is rotated, relative to the radiation source and the radiation detector, by an amount corresponding to an angle range of the radiation source of the N-th projection-data collector.

According to the above configuration, since the inter-device conveyance device rotates the subject between the N-th projection-data collector and the (N+1)-th projection-data collector, the cone-beam projection data, in which the projection angles at which radiation passes through the subject continuously change at certain angular intervals, can be efficiently collected.

A radiation CT system according to a seventh aspect of the present teaching is configured such that, in addition to the fifth aspect, when projection data over an angle range of 180 degrees or 360 degrees is collected up to an N-th projection-data collector, the imaging controller of an (N+1)-th projection-data collector in the plurality of projection-data collectors collects the cone-beam projection data by imaging the subject in a state where the subject is relatively moved by an amount corresponding to a half channel in at least one of the channel direction and the height direction relative to imaging performed in the N-th projection-data collector in the plurality of projection-data collectors.

According to the above configuration, the spatial resolution of the tomographic image or three-dimensional data reconstructed from the projection data can be improved in at least one of the channel direction and the height direction. As a result, a tomographic image of higher accuracy can be obtained.

### Advantageous Effects of Invention

A radiation CT device according to one aspect of the present teaching includes: a radiation source configured to emit cone-beam radiation that spreads three-dimensionally along an optical axis direction; a radiation detector positioned on one side of the optical axis direction with respect to the radiation source, the radiation detector having channels for detecting the radiation arranged in a two-dimensional array; a moving device configured to pass the subject through the radiation by moving the subject relative to the radiation source and the radiation detector in a movement direction intersecting the optical axis direction; a cone-beam projection data collector configured to collect cone-beam projection data, which is acquired by projecting the cone-beam radiation onto the radiation detector, at respective positions in the movement direction, by detecting, with the radiation detector, the radiation emitted from the radiation source onto the subject that is relatively moved in the movement direction by the moving device; and a reconstructor configured to reconstruct a tomographic image or three-dimensional data based on the collected cone-beam projection data.

The above aspect makes it possible to provide a radiation CT device that allows further space saving while enabling collection of projection data in a given angle range of a subject that is continuously conveyed in one direction, thereby reconstructing it as three-dimensional data in which tomographic images are stacked.

### BRIEF DESCRIPTION OF DRAWINGS

FIG. 1 is a functional block diagram showing a schematic configuration of a radiation CT device according to Embodiment 1.

FIG. 2 is a diagram schematically illustrating cone-beam projection data acquired at each view position.

FIG. 3A and FIG. 3B illustrate graphs each showing a reconstruction function in a frequency domain.

FIG. 4 is a functional block diagram showing a schematic configuration of a radiation CT device according to Embodiment 2.

FIG. 5 is a diagram illustrating processing for extracting data corresponding to beams at specific radiation angles from n datasets of cone-beam projection data.

FIG. 6 is a diagram schematically illustrating parallel-beam projection data acquired by fan-to-parallel conversion of cone-beam projection data based on a radiation angle.

FIG. 7 is a functional block diagram showing a schematic configuration of a radiation CT device according to Embodiment 3.

FIG. 8 is a cross-sectional view showing an internal configuration of a subject, which is a battery.

FIG. 9 is a flowchart showing a flow of an inspection method in the radiation CT device according to Embodiment 3.

FIG. 10 is a functional block diagram showing a schematic configuration of a radiation CT system according to Embodiment 4.

FIG. 11 is a functional block diagram showing a schematic configuration of a radiation CT system according to Embodiment 5.

FIG. 12 is a functional block diagram showing a schematic configuration of a radiation CT system according to Embodiment 6.

FIG. 13 is a diagram showing a specific example of an inter-device conveyance device.

### DESCRIPTION OF EMBODIMENTS

Hereinafter, embodiments of the present teaching will be described in detail with reference to the drawings. Note that the same reference signs are given to identical or corresponding parts in the drawings, and description thereof is not repeated. Also, the dimensions of the components in each drawing do not accurately represent the actual dimensions of the components or dimensional ratios thereof.

In each drawing, the arrow X indicates the X-axis in a coordinate system of radiation CT devices 1, 2, 3, or the like, the arrow Y indicates the Y-axis in a coordinate system of the radiation CT device 1, or the like, and the arrow Z indicates the Z-axis in a coordinate system of the radiation CT device 1, or the like. Note that, the Z-axis is also referred to as a height direction in a coordinate system of the radiation CT devices 1, 2, 3, or the like. In each drawing, the arrow Q indicates an optical axis direction in a coordinate system of the radiation CT devices 1, 2, 3, or the like.

### Embodiment 1

### Overall Configuration

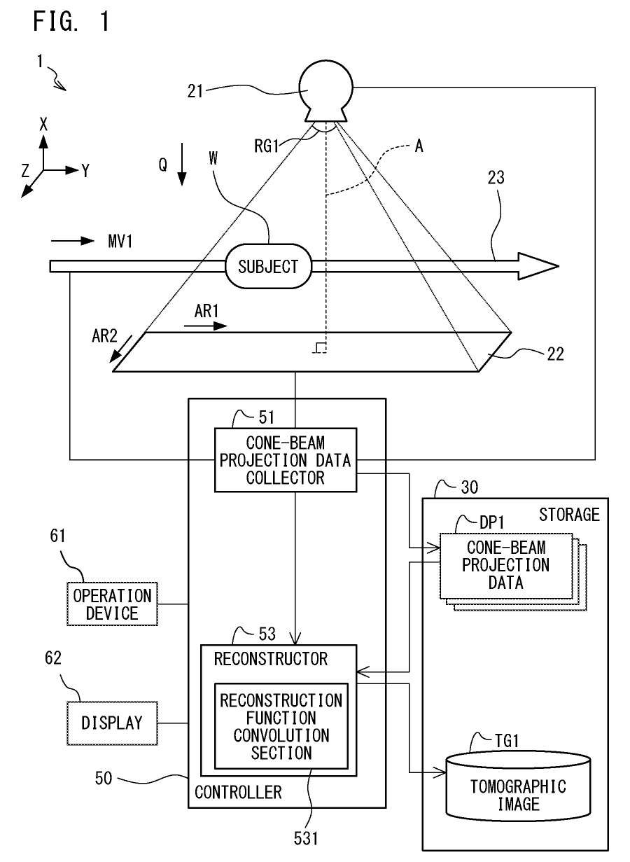

FIG. 1 is a functional block diagram showing a schematic configuration of a radiation CT device 1 according to Embodiment 1. The radiation CT device 1 is, for example, a device that reconstructs a tomographic image TG1 or three-dimensional data based on projection data acquired by irradiating a subject W with radiation. In the following example, image reconstruction of the tomographic image TG1 is mainly described. The radiation is, for example, X-rays. Therefore, the radiation CT device 1 is, for example, an X-ray CT device.

As shown in FIG. 1, the radiation CT device 1 includes a radiation source 21, a radiation detector 22, a moving device 23, a storage 30, a controller 50, an operation device 61, and a display 62.

The radiation source 21 emits X-rays that spread three-dimensionally in an optical axis direction Q in which an optical axis A extends. The radiation source 21 emits, for example, cone-beam X-rays toward the radiation detector 22 positioned in one direction along the optical axis direction Q.

The radiation source 21 emits X-rays that spread, when viewed in a height direction Z in the coordinate system of the radiation source 21 and the radiation detector 22, over a detection surface of the radiation detector 22 within a radiation angle range RG1 around the optical axis A. The radiation angle range RG1 is, for example, an angle of 90°.

The radiation detector 22 is positioned on one side of the optical axis direction Q with respect to the radiation source 21. The radiation detector 22 is configured such that detection elements that detect X-rays are arranged in a channel direction AR1 and a column direction AR2 in a two-dimensional array.

The channel direction AR1 is one of the directions orthogonal to the optical axis direction Q. The channel direction AR1 is a direction along a movement direction MV1, which is described later. The column direction AR2 is a direction along the height direction Z. The column direction AR2 is, for example, orthogonal to the channel direction AR1. The detection surface configured in a two-dimensional array in the radiation detector 22 is, for example, orthogonal to the optical axis A.

The radiation source 21 emits X-rays in the form of a cone-beam onto a plane extending in the channel direction AR1 and the column direction AR2. The radiation detector 22 outputs a signal based on the intensity of detected X-rays.

The moving device 23 translationally moves the subject W relative to the radiation source 21 and the radiation detector 22 in a movement direction MV1 on a conveyance path located between the radiation source 21 and the radiation detector 22. As a result, the subject W passes through an X-ray beam emitted from the radiation source 21 to the radiation detector 22. The movement direction MV1 is, for example, a direction orthogonal to the optical axis direction Q. The moving device 23 can be configured, for example, by a conveyor belt or the like.

The storage 30 stores various types of data including a program executed by the controller 50 and data used by the program. For example, the storage 30 stores cone-beam projection data DP1 and the tomographic image TG1.

The cone-beam projection data DP1 is acquired by imaging the subject W that successively moves between the respective positions in the movement direction MV1.

The tomographic image TG1 is image data acquired by performing reconstruction based on the cone-beam projection data DP1.

The storage 30 can be implemented by, for example, a volatile or non-volatile storage device. The storage 30 is, for example, a non-transitory tangible storage medium. As an example, the storage 30 can be implemented by a built-in storage device, an external storage device, or removable media. As another example, the storage 30 can be implemented by cache memory and a main storage device. Further, as still another example, the storage 30 can be implemented by an auxiliary storage device such as an SSD (Solid State Drive) or an HDD (Hard Disk Drive).

The controller 50 reads out a program stored in the storage 30, and executes the program thus read out by a computing device such as a CPU (Central Processing Unit), a GPU (Graphics Processing Unit), or an MPU (Micro Processing Unit), thereby implementing the various functions. The details of the controller 50 will be described later.

The operation device 61 is a user interface for performing various operations in the radiation CT device 1. The operation device 61 can be implemented, for example, by an input device such as a keyboard or buttons, or by a pointing device such as a mouse, a pen tablet, or a touch panel. For example, various operations including an imaging operation in the radiation CT device 1 can be performed through the operation device 61 by an operator.

The display 62 presents various types of data in the radiation CT device 1 to a user. The display 62 can be implemented by a display device such as a liquid crystal display or an organic EL display. The display 62 may be integrated with the operation device 61, for example, as a touch panel.

### Details of Controller

The controller 50 includes a cone-beam projection data collector 51 and a reconstructor 53.

### Cone-Beam Projection Data Collector

The cone-beam projection data collector 51 captures an image of the subject W by controlling the radiation source 21, the radiation detector 22, and the moving device 23. The cone-beam projection data collector 51 detects, by the radiation detector 22, X-rays emitted from the radiation source 21 onto the subject W that is relatively moved in the movement direction MV1 by the moving device 23. This allows the cone-beam projection data collector 51 to collect the cone-beam projection data DP1, which is acquired by projecting X-rays in the form of a cone-beam (when viewed in the height direction Z) onto the radiation detector 22, at each view position in the movement direction MV1. Each view position is associated with a phase in the movement direction MV1 of the subject W. Each view position may be associated, for example, with a movement distance or an elapsed time from a start of conveyance in the movement direction MV1.

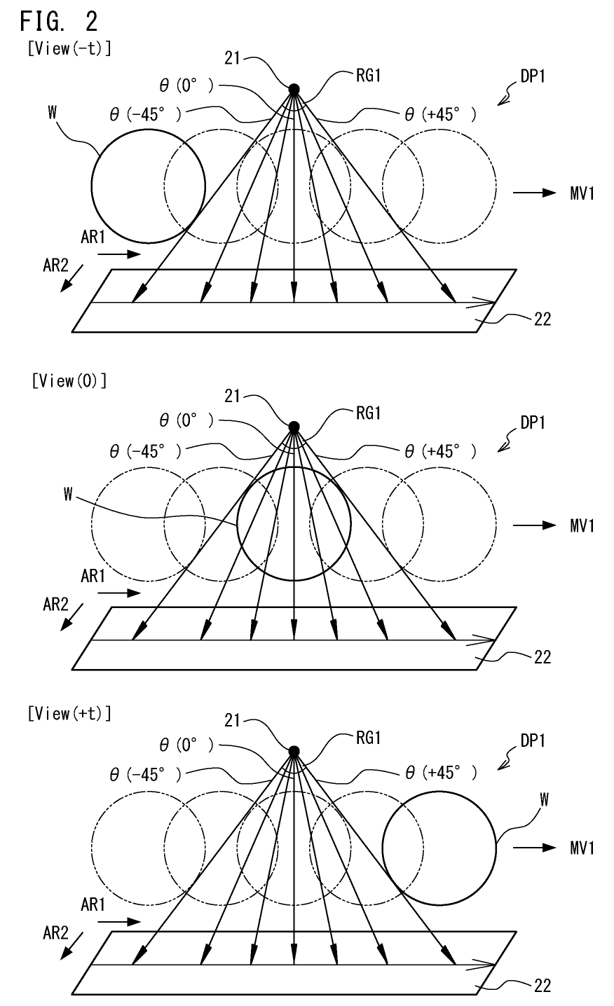

FIG. 2 is a diagram schematically illustrating the cone-beam projection data DP1 acquired at each of the view positions View (-t), View (0), and View (+t). Referring to FIG. 2, the radiation angle range RG1 of the radiation source 21 is, for example, a total of 90°, from -45° to +45°, assuming that 0° corresponds to an angle aligned with the optical axis.

In FIG. 2, the solid line shows a position of the subject W at each view position, and the two-dot chain lines indicate a trajectory of the subject W being conveyed. The radiation angle range RG1 may be a range greater than 0° and less than 180°. The radiation angle range RG1 may preferably be a range between 60° and 120°.

Therefore, the cone-beam projection data DP1 collected by the cone-beam projection data collector 51 refers to data acquired by limited-angle projection over an angle range smaller than 360°, not the entire angle range, i.e., 360° with respect to the subject W.

In the cone-beam projection data DP1 at the view position View (-t), the subject W has moved from outside the radiation angle range RG1 to a position in contact with a line at a radiation angle θ = -45°. In the cone-beam projection data DP1 at the view position View (0), the subject W has moved to a position where the center of the subject W reaches a position at a radiation angle θ = 0°. In the cone-beam projection data DP1 at the view position View (+t), the subject W has passed the line at a radiation angle θ = +45° and moved to a position outside the radiation angle range RG1.

The cone-beam projection data collector 51 stores the collected cone-beam projection data DP1 in the storage 30.

### Reconstructor

The reconstructor 53 reconstructs the tomographic image TG1 of the subject W based on the cone-beam projection data DP1.

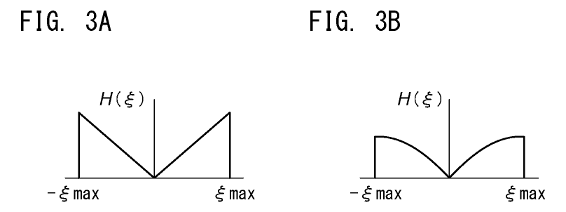

FIGS. 3A and 3B illustrate graphs each showing a reconstruction function H(ξ) in a frequency domain. The reconstructor 53 may use a Ramachandran–Lakshminarayanan filter (Ram–Lak filter) shown in FIG. 3A as the reconstruction function H(ξ). Alternatively, the reconstructor 53 may use a Shepp–Logan filter shown in FIG. 3B as the reconstruction function H(ξ). ξmax shown in FIGS. 3A and 3B is a maximum spatial frequency contained in the cone-beam projection data DP1.

Ram–Lak filter is known to have excellent resolution. Since Ram–Lak filter has a property of emphasizing high-frequency components, it tends to emphasize high-frequency components that constitute noise in an image. In contrast, Shepp–Logan filter is one type of filter adjusted to suppress gain of high-frequency components. By using Shepp–Logan filter, noise in the tomographic image TG1 can be reduced overall.

The reconstructor 53 can reconstruct the tomographic image TG1 by a three-dimensional backprojection method based on the cone-beam projection data DP1 convoluted with the reconstruction function H(ξ).

The reconstructor 53 stores the tomographic image TG1 in the storage 30. The reconstructor 53 may also perform post-processing, such as conversion of the CT values in the reconstructed tomographic image TG1 or applying a filter to the tomographic image TG1.

Further, when the tomographic image TG1 is reconstructed based on the cone-beam projection data DP1 that is acquired over a radiation angle range RG1 of the radiation source 21 that is less than 180°, artifacts (false images) may occur.

The reconstructor 53 includes a reconstruction function convolution section 531 that suppresses artifacts occurring in the tomographic image TG1 when the radiation angle range RG1 of the radiation source 21 in which the cone-beam projection data DP1 is acquired is less than 180°.

For example, when an artifact appears in the tomographic image TG1 as a white region due to a high CT value, the reconstruction function convolution section 531 may apply a low-frequency enhancement filter to the tomographic image TG1 to reduce or remove high-frequency components in the white region.

Further, the reconstruction function convolution section 531 may correct the tomographic image TG1 by AI. For example, the reconstruction function convolution section 531 may remove or reduce white regions that appear as limited-angle artifacts in the tomographic image TG1 by using a trained model acquired through machine learning performed by a computer.

By adjusting the frequency components of the reconstruction function so as to mitigate such artifacts, the artifacts can be suppressed to some extent.

With the above configuration, the reconstruction function convolution section 531 suppresses the artifacts as described above, and a tomographic image TG1 or three-dimensional data that is visually easier to recognize or easier to evaluate during image processing can be reconstructed.

According to the radiation CT device 1, the tomographic image TG1 can be reconstructed by sequentially imaging the subject W with a simpler device configuration and a lower computational load.

The tomographic image TG1 stored in the storage 30 by the reconstructor 53 can be displayed on the display 62 in response to an operator’s operation at the operation device 61.

### Embodiment 2

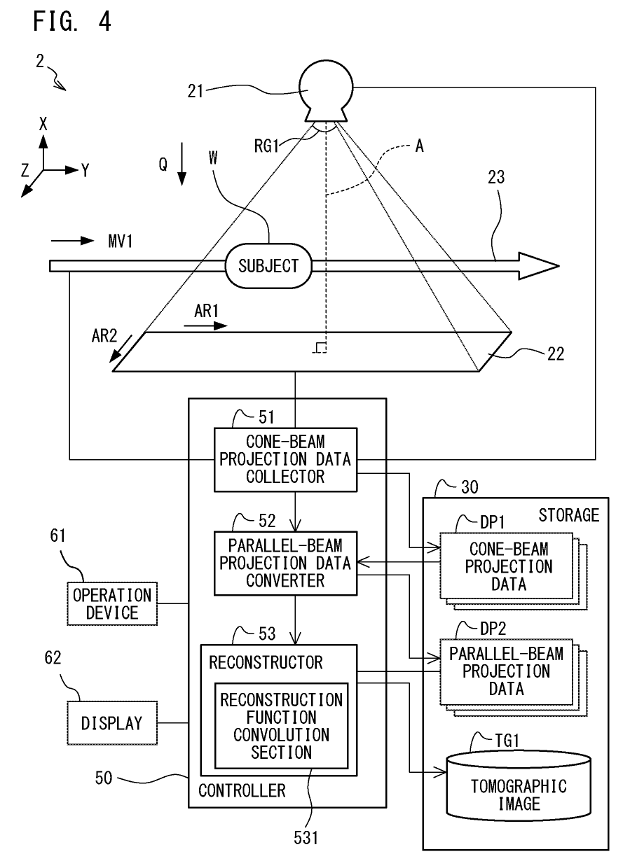

FIG. 4 is a functional block diagram showing a schematic configuration of a radiation CT device 2 according to Embodiment 2. The radiation CT device 2 according to Embodiment 2 further includes a parallel-beam projection data converter 52, as compared with the radiation CT device 1 according to Embodiment 1. Note that, in the description of Embodiment 2, detailed description of parts in common with Embodiment 1 is not repeated.

### Overall Configuration

As shown in FIG. 4, the radiation CT device 2 includes the radiation source 21, the radiation detector 22, the moving device 23, the storage 30, the controller 50, the operation device 61, and the display 62.

The storage 30 stores various types of data including a program executed by the controller 50 and data used by the program. For example, the storage 30 stores the cone-beam projection data DP1, parallel-beam projection data DP2, and the tomographic image TG1.

The parallel-beam projection data DP2 is data corresponding to projection of a parallel beam through the subject W, acquired based on the collected cone-beam projection data DP1.

The controller 50 includes the cone-beam projection data collector 51, the parallel-beam projection data converter 52, and the reconstructor 53.

### Parallel-Beam Projection Data Converter

The parallel-beam projection data converter 52 acquires the parallel-beam projection data DP2 corresponding to projection of a parallel beam through the subject W based on the collected cone-beam projection data DP1.

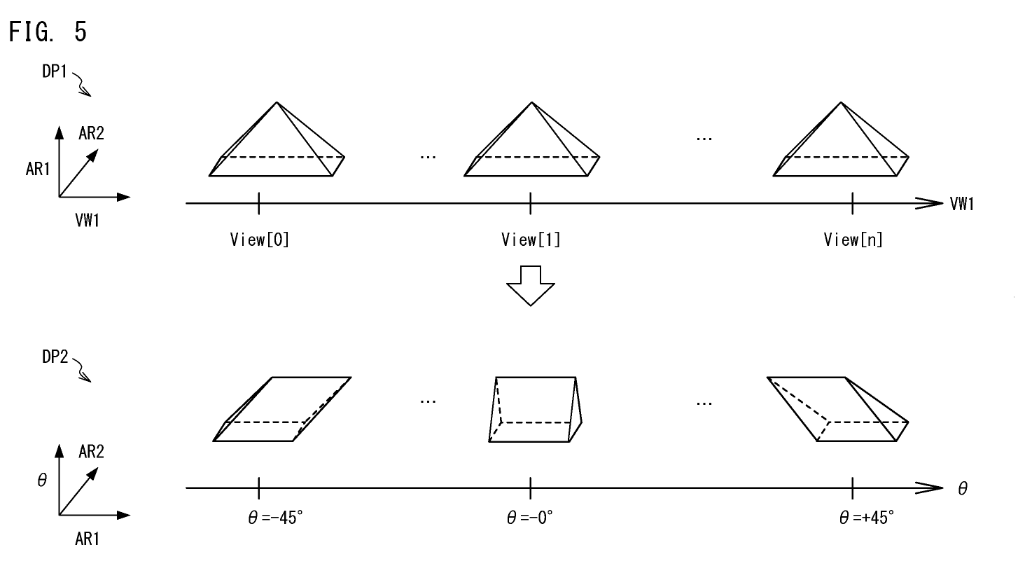

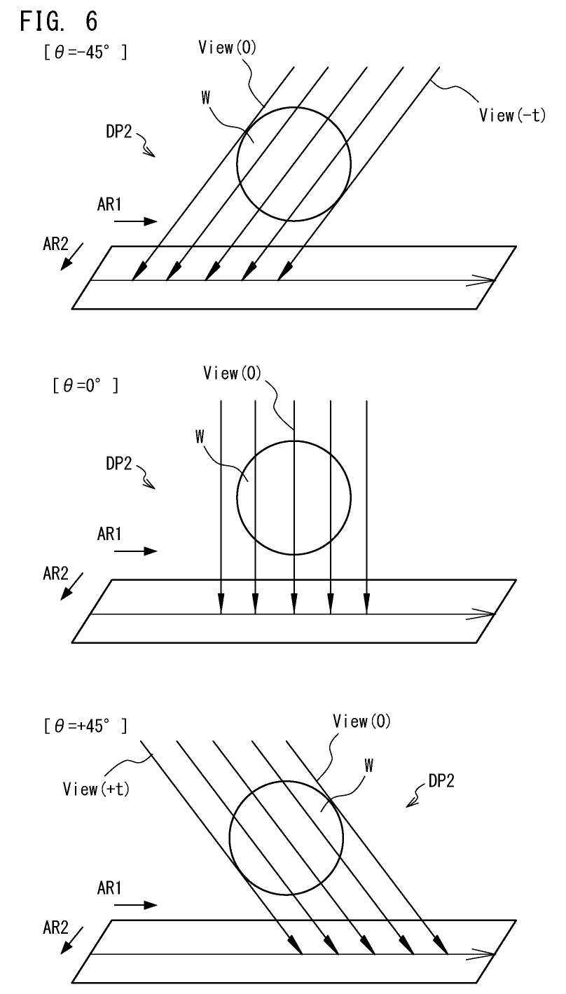

FIG. 5 is a diagram illustrating processing for extracting data corresponding to beams at radiation angles θ = -45°, 0°, and +45° from n datasets of the cone-beam projection data DP1. FIG. 6 is a diagram schematically illustrating the parallel-beam projection data DP2 acquired by fan-to-parallel conversion of the cone-beam projection data DP1 based on the radiation angle θ. The numbers in brackets in FIG. 5 represent an order of view positions in the cone-beam projection data DP1. Hereinafter, displacement of the view position is referred to as a view direction VW1.

Referring to FIG. 5, the n datasets of the cone-beam projection data DP1 collected at the respective view positions View [0], View [1], …, View [n] each relate to a quadrangular pyramid-shaped space having the radiation source 21 as its apex and a detection surface of the radiation detector 22 as its base. The parallel-beam projection data converter 52 first extracts data corresponding to beams at each angle within the radiation angle range RG1 of the radiation source 21.

The parallel-beam projection data converter 52 extracts, for example, data corresponding to radiation angles θ of -45°, 0°, and +45° from the cone-beam projection data DP1 at the respective view positions View [0], View [1], …, View [n] shown in the upper part of FIG. 5. In this manner, the parallel-beam projection data converter 52 acquires the parallel-beam projection data DP2 for each radiation angle θ.

From another perspective, the parallel-beam projection data converter 52 performs processing for mapping spatial coordinates of the cone-beam projection data DP1, which is represented by the channel direction AR1, the column direction AR2, and the view direction VW1, to spatial coordinates of the parallel-beam projection data DP2, which is represented by the radiation angle θ, the column direction AR2, and the channel direction AR1.

Specifically, the parallel-beam projection data converter 52 rearranges the cone-beam projection data DP1 such that the channel direction AR1 of the cone-beam projection data DP1 corresponds to an angular direction based on the radiation angle θ in the parallel-beam projection data DP2, and the view direction VW1 of the cone-beam projection data DP1 corresponds to the channel direction AR1 in the parallel-beam projection data DP2.

Referring to FIG. 6, more specifically, the parallel-beam projection data converter 52 generates the parallel-beam projection data DP2 for each of the radiation angles θ of -45°, 0°, and +45° by collecting data corresponding to beams at the radiation angles θ of -45°, 0°, and +45° at the respective view positions. Accordingly, the parallel-beam projection data DP2 for one radiation angle θ contains data corresponding to beams having the radiation angle θ and being parallel to each other in the cone-beam projection data DP1 at each view position.

Note that, in FIG. 6, only the beams that contact or pass through the subject W are shown for simplicity of illustration. The parallel-beam projection data DP2 for each radiation angle θ may contain data corresponding to beams at the view positions View(-t) to View(+t).

The parallel-beam projection data converter 52 stores the parallel-beam projection data DP2 thus acquired in the storage 30.

The reconstructor 53 reconstructs the tomographic image TG1 of the subject W based on the parallel-beam projection data DP2.

The parallel-beam projection data converter 52 converts the cone-beam projection data DP1 into the parallel-beam projection data DP2 in a parallel-beam format, which corresponds to projection of a parallel beam through the subject W, by changing the reading method of the cone-beam projection data DP1 in the form of a cone beam. In this way, the reconstructor 53 is capable of reconstructing the tomographic image TG1 by way of a back-projection method for parallel beams.

### Embodiment 3

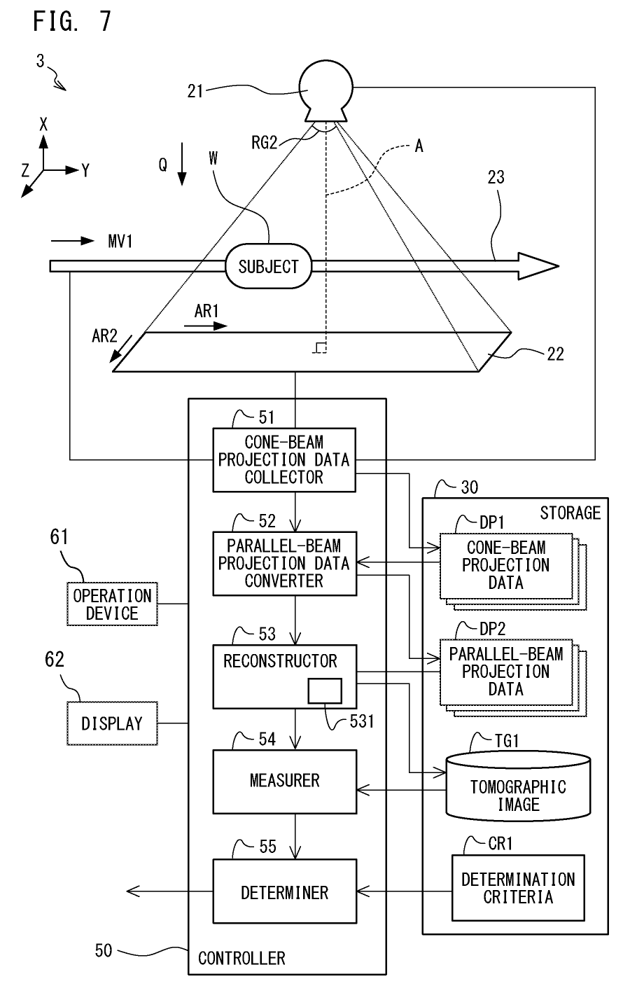

FIG. 7 is a functional block diagram showing a schematic configuration of a radiation CT device 3 according to Embodiment 3. The radiation CT device 3 according to Embodiment 3 performs inspection of the subject W, which is a battery. Note that, in the description of Embodiment 3, detailed description of parts in common with Embodiment 1 is not repeated.

### Overall Configuration

As shown in FIG. 7, the radiation CT device 3 includes the radiation source 21, the radiation detector 22, the moving device 23, the storage 30, the controller 50, the operation device 61, and the display 62. The radiation angle range RG2 of the radiation source 21 is 60°.

The storage 30 stores the cone-beam projection data DP1, the parallel-beam projection data DP2, the tomographic image TG1, and determination criteria CR1. The determination criteria CR1 refer to criteria used to determine whether the dimensions of the target object fall within a predetermined range.

The controller 50 includes the cone-beam projection data collector 51, the parallel-beam projection data converter 52, the reconstructor 53, a measurer 54, and a determiner 55.

The measurer 54 measures dimensions of the target object in the tomographic image TG1. The target object is, for example, an electrode body of the subject W, which is a battery.

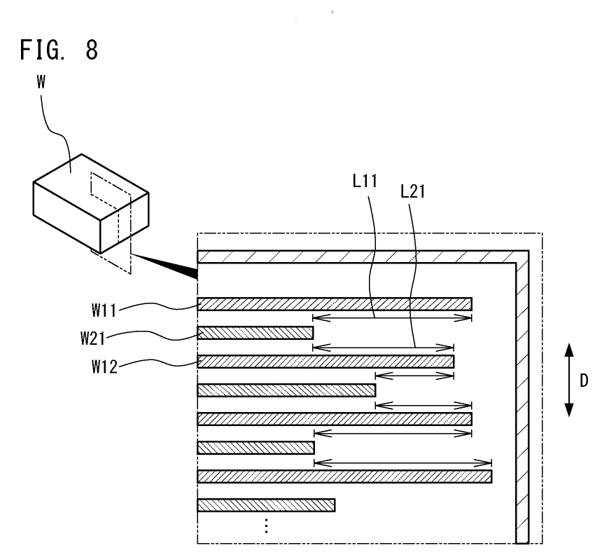

FIG. 8 is a cross-sectional view showing the internal configuration of the subject W, which is a battery. Referring to FIG. 8, the subject W, which is a battery, includes positive electrodes W11 and W12 and a negative electrode W21, which are alternately stacked in a stacking direction D inside a casing. The measurer 54 measures deviation amounts of the positive electrodes W11 and W12 and the negative electrode W21. A deviation amount L11 between the positive electrode W11 and the negative electrode W21 located on one side in the stacking direction of the positive electrode W11 is a distance between one end of the positive electrode W11 and one end of the negative electrode W21. A deviation amount L21 between the negative electrode W21 and the positive electrode W12 located on one side in the stacking direction of the negative electrode W21 is a distance between one end of the negative electrode W21 and one end of the positive electrode W12.

The determiner 55 determines whether the dimensions of the target object fall within a predetermined range with reference to the determination criteria CR1. Specifically, when the dimensions of the electrode body of the subject W fall within the predetermined range, the determiner 55 outputs a determination result indicating “Pass”, and when the dimensions of the electrode body of the subject W fall outside the predetermined range, the determiner 55 outputs a determination result indicating “Fail”.

### Flow of Pass/Fail Determination Process

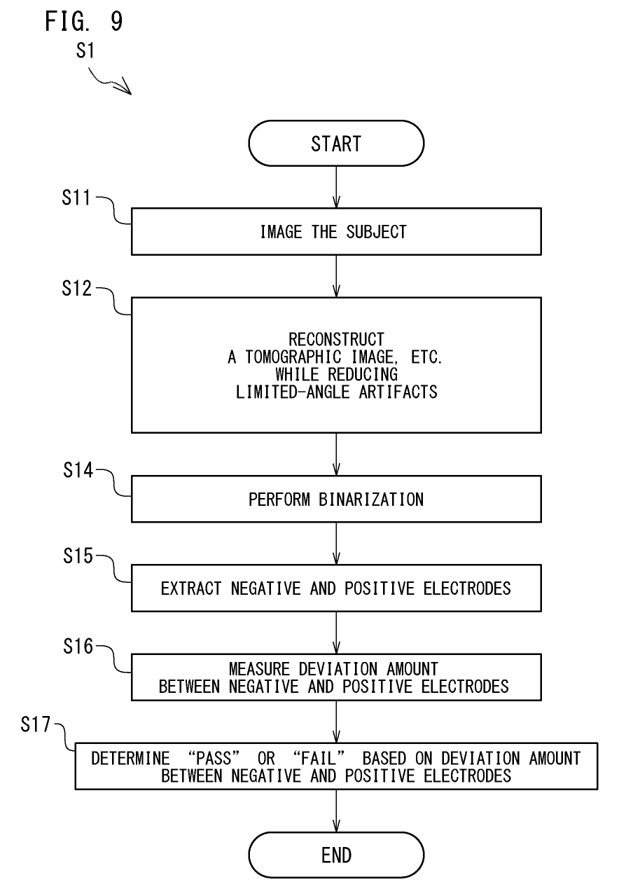

FIG. 9 is a flowchart showing a flow of an inspection method S1 in the radiation CT device 3 according to Embodiment 3. Referring to FIGS. 7 to 9, in the inspection method S1, the electrode body of the battery is inspected by performing the steps S11 to S17 as described below.

First, in the inspection method S1, the subject W is imaged by the radiation CT device 3. Specifically, the radiation source 21, having a radiation angle range RG2 of 60°, emits X-rays onto the electrode body of the subject W that is being translationally moved in the movement direction MV1, and the emitted X-rays are detected by the radiation detector 22 (step S11). The cone-beam projection data collector 51 then collects the cone-beam projection data DP1. Further, the parallel-beam projection data converter 52 acquires the parallel-beam projection data DP2 based on the cone-beam projection data DP1.

Then, the reconstructor 53 reconstructs the tomographic image TG1 based on the parallel-beam projection data DP2.

In this image reconstruction processing, the reconstruction function convolution section 531 of the reconstructor 53 reconstructs the tomographic image TG1 using a reconstruction function configured to remove or reduce limited-angle artifacts in the tomographic image TG1 (step S12).

Next, after the measurer 54 performs shading correction on the tomographic image TG1 corrected by the reconstruction function convolution section 531 so that the background brightness of the image becomes uniform, the tomographic image TG1 having been through the shading correction is binarized using a binarization threshold that enables detection of the electrode body of the subject W, which is a battery (step S14).

Next, the measurer 54 extracts the negative electrode W21 and the positive electrodes W11 and W12 in the binarized image obtained by binarizing the tomographic image TG1 (step S15). The measurer 54may extract the negative electrode W21 and the positive electrodes W11 and W12, for example, as described below. First, the measurer 54 extracts the positive electrodes W11 and W12 by applying n iterations of erosion filtering and n iterations of dilation filtering to the binarized image to remove the negative electrode W21. Further, the measurer 54 extracts the negative electrode W21 by subtracting the extracted positive electrodes W11 and W12 from the binarized image.

Next, the measurer 54 removes noise from the extracted images of the negative electrode W21 and the positive electrodes W11 and W12, and also measures the deviation amounts L11 and L21 of the negative electrode W21 and the positive electrodes W11 and W12 (step S16). The measurer 54 may output the deviation amounts L11 and L21 to an external server or record them in the storage 30.

Next, the determiner 55 determines whether the deviation amounts L11 and L21 of the subject W fall within the predetermined range (step S17). The determiner 55 displays the determination result on the display 62. The determiner 55 may output the determination result to an external server or record it in the storage 30.

According to the above configuration, for example, the results indicating “Pass” or “Fail” for the target object can be determined based on the determination criteria for dimensional specifications of the manufactured target objects.

### Embodiment 4

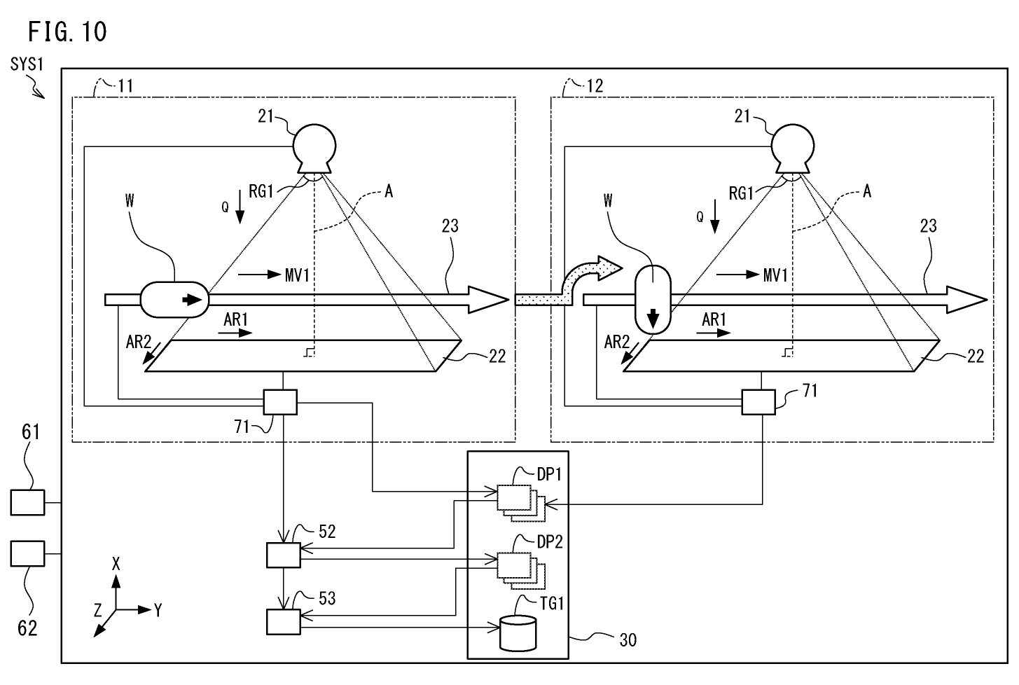

FIG. 10 is a functional block diagram showing a schematic configuration of a radiation CT system SYS1 according to Embodiment 4. The radiation CT system SYS1 according to Embodiment 4 includes two projection-data collectors 11 and 12. Note that, in the description of Embodiment 4, detailed description of parts in common with Embodiment 1 is not repeated.

Referring to FIG. 10, the radiation CT system SYS1 includes a plurality of projection-data collectors, i.e., a first projection-data collector 11 and a second projection-data collector 12, the storage 30, the parallel-beam projection data converter 52, the reconstructor 53, the operation device 61, and the display 62.

The first projection-data collector 11 and the second projection-data collector 12 collect projection data acquired by irradiating the subject W with radiation.

The first projection-data collector 11 and the second projection-data collector 12 each include the radiation source 21, the radiation detector 22, the moving device 23, and an imaging controller 71.

In the first projection-data collector 11 and the second projection-data collector 12, the radiation angle range RG1 of the radiation source 21 is 90°. The first projection-data collector 11 and the second projection-data collector 12 have identical orientations of the optical axis direction Q of the radiation source 21.

The imaging controller 71 collects the cone-beam projection data DP1 at each view position in the movement direction MV1 by detecting, with the radiation detector 22, X-rays emitted from the radiation source 21 onto the subject W that is being relatively moved in the movement direction MV1 by the moving device 23.

In the radiation CT system SYS1, first, the subject W is imaged by the first projection-data collector 11. The first projection-data collector 11 collects the cone-beam projection data DP1 in the initial angle range from 0° to 90°.

Next, in the second projection-data collector 12, the subject W is imaged in a state where the subject W is rotated by 90° around a central axis extending in the height direction Z. The second projection-data collector 12 then collects the cone-beam projection data DP1 in the next 90° angle range, which is from 90° to 180°. In this manner, in the radiation CT system SYS1, the cone-beam projection data DP1 is collected by imaging the subject W such that the projection angles with respect to the subject W correspond to continuous imaging directions.

As a result, the radiation CT system SYS1 collects the cone-beam projection data DP1 over the total angle range of 180°. The parallel-beam projection data converter 52 acquires the parallel-beam projection data DP2 based on the cone-beam projection data DP1 over the total angle range of 180°.

According to the above configuration, the parallel-beam projection data DP2 can be obtained based on the cone-beam projection data DP1, which are sequentially collected while changing the relative angle of the subject W by the first projection-data collector 11 and the second projection-data collector 12. This allows the reconstructor 53 to perform reconstruction processing based on the parallel-beam projection data DP2 collected and converted within a half-scan angle range of 180°. Therefore, a tomographic image TG1 with further reduced artifacts can be obtained.

### Embodiment 5

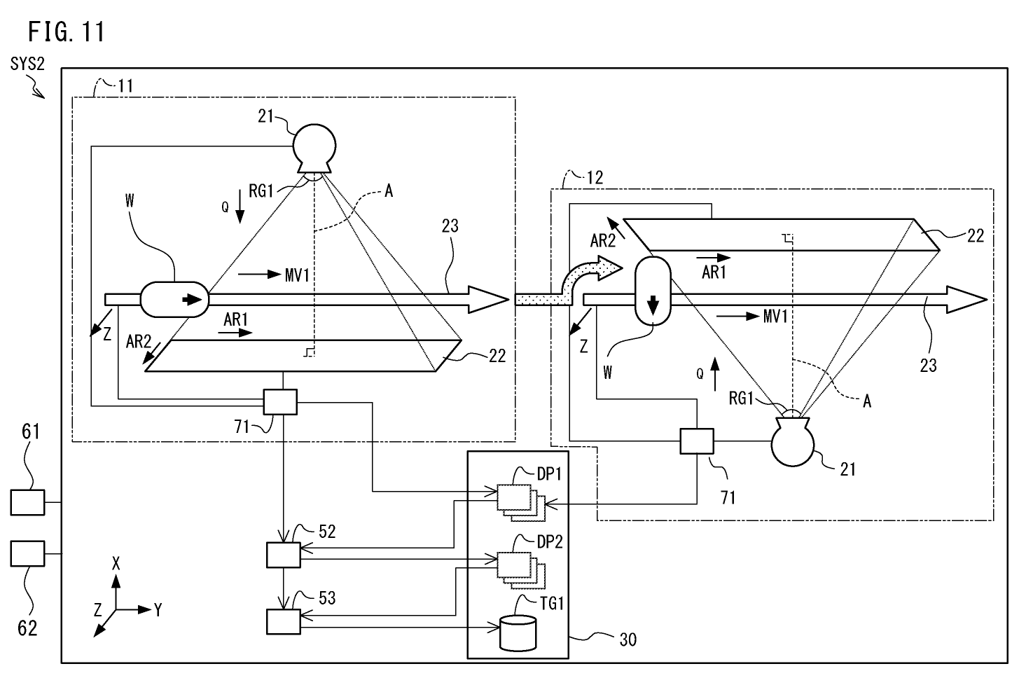

FIG. 11 is a functional block diagram showing a schematic configuration of a radiation CT system SYS2 according to Embodiment 5. The radiation CT system SYS2 according to Embodiment 5 differs from the radiation CT system SYS1 according to Embodiment 4 in that the two projection-data collectors 11 and 12 are oppositely oriented. Note that, in the description of Embodiment 5, detailed description of parts in common with Embodiment 1 is not repeated.

Referring to FIG. 11, the radiation CT system SYS2 includes a plurality of projection-data collectors, i.e., the first projection-data collector 11 and the second projection-data collector 12, the storage 30, the parallel-beam projection data converter 52, the reconstructor 53, the operation device 61, and the display 62.

The first projection-data collector 11 and the second projection-data collector 12 have opposite orientations of the optical axis direction Q of the radiation source 21.

The first projection-data collector 11 collects the cone-beam projection data DP1 in the angle range from 0° to 90° based on a given reference direction of the subject W.

Next, in the second projection-data collector 12, the subject W is imaged in a state where the subject W is rotated by 90° around a central axis extending in the height direction Z. The second projection-data collector 12 collects the cone-beam projection data DP1 in the angle range from 0° to -90° based on a given reference direction of the subject W. Accordingly, the radiation CT system SYS2 collects the cone-beam projection data DP1 over a continuous angle range of 180° covering the total angle of 180° with respect to the subject W.

Similarly to the radiation CT system SYS1, the radiation CT system SYS2 is also capable of collecting the cone-beam projection data DP1 over a continuous angle range of 180°. According to the radiation CT system SYS2, the X-ray data collection system can be disposed using less space in the movement direction MV1 compared with the radiation CT system SYS1, while still enabling accurate reconstruction of the tomographic image TG1 of the subject W.

### Embodiment 6

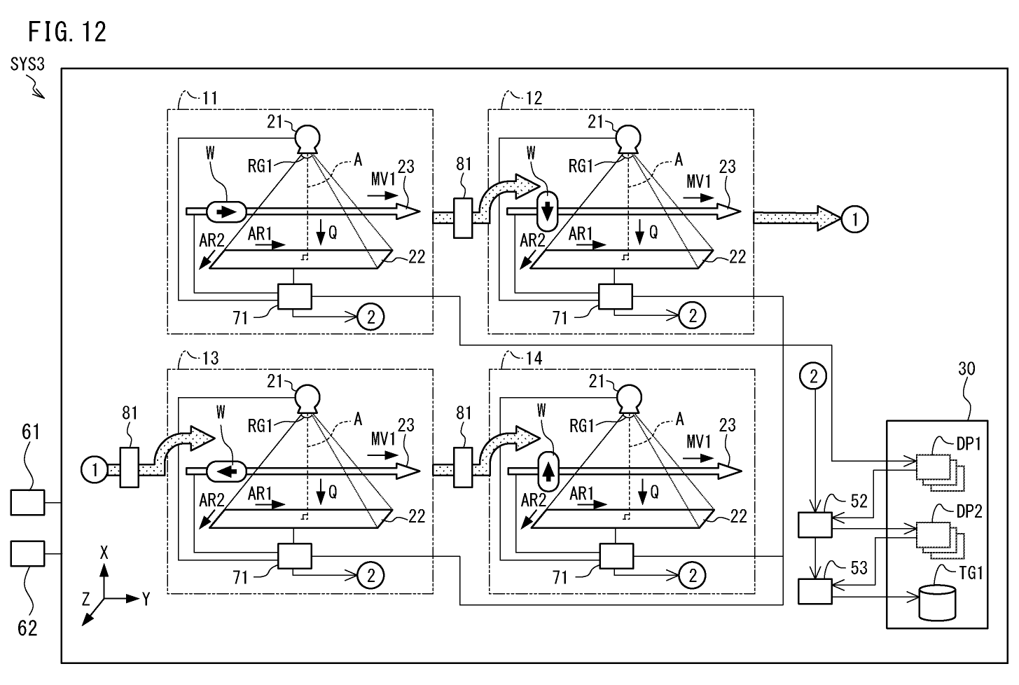

FIG. 12 is a functional block diagram showing a schematic configuration of a radiation CT system SYS3 according to Embodiment 6. The radiation CT system SYS3 according to Embodiment 6 includes four projection-data collectors 11, 12, 13, and 14, each having an X-ray radiation angle that extends over 90° within the XY-plane. Note that, in the description of Embodiment 6, detailed description of parts in common with Embodiment 4 is not repeated.

Referring to FIG. 12, the radiation CT system SYS3 includes a plurality of projection-data collectors, i.e., the first projection-data collector 11, the second projection-data collector 12, the third projection-data collector 13, and the fourth projection-data collector 14, and further includes the storage 30, the parallel-beam projection data converter 52, the reconstructor 53, the operation device 61, the display 62, and an inter-device conveyance device 81.

Similarly to the first projection-data collector 11 and the second projection-data collector 12, the third projection-data collector 13 and the fourth projection-data collector 14 each include the radiation source 21, the radiation detector 22, the moving device 23, and the imaging controller 71.

The radiation angle range RG1 of the radiation source 21 is 90° in the third projection-data collector 13 and the fourth projection-data collector 14.

The inter-device conveyance devices 81 are located between the plurality of projection-data collectors. More specifically, the inter-device conveyance devices 81 are respectively located between the first projection-data collector 11 and the second projection-data collector 12, between the second projection-data collector 12 and the third projection-data collector 13, and between the third projection-data collector 13 and the fourth projection-data collector 14.

Each of the inter-device conveyance devices 81 conveys the subject W from the terminal end of the moving device 23 of the N-th (N = 1, 2, 3) data collector to the starting end of the moving device 23 of the (N+1)-th data collector. The inter-device conveyance device 81 may be connected linearly to the conveyance path of the N-th data collector and the conveyance path of the (N+1)-th data collector, or may be connected to them in a bent manner.

The inter-device conveyance device 81 conveys the subject W, which is conveyed from the terminal end of the moving device 23 of the N-th data collector, to the starting end of the moving device 23 of the (N+1)-th data collector in a state where the subject W is rotated by an amount corresponding to the angle range of the radiation source of the N-th data collector relative to the radiation source 21 and the radiation detector 22.

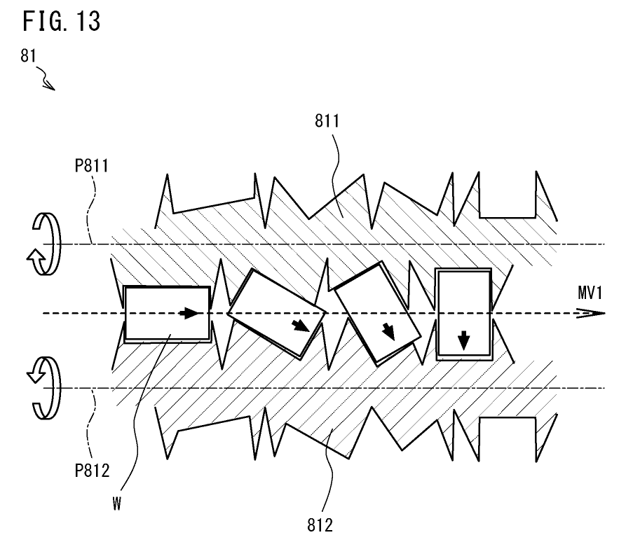

FIG. 13 is a diagram showing a specific example of the inter-device conveyance device 81. Referring to FIG. 13, the inter-device conveyance device 81 includes, for example, two-axis screw conveyors 811 and 812. The screw conveyors 811 and 812 are located on both sides of the conveyance path extending in the movement direction MV1.

The screw conveyors 811 and 812 rotate respectively around rotation axes P811 and P812 extending in parallel with the movement direction MV1, thereby moving the subject W in the movement direction MV1 while rotating the subject W, for example, by 90°. The inter-device conveyance device 81 sends out the subject W from the terminal end of the inter-device conveyance device 81 in a state where the subject W has been rotated by 90° relative to the subject W at the starting end of the inter-device conveyance device 81.

According to the above configuration, since the inter-device conveyance device 81 rotates the subject W between the N-th data collector and the (N+1)-th data collector, the cone-beam projection data DP1 and the parallel-beam projection data DP2, in which the projection angles at which radiation passes through the subject W continuously change at certain angular intervals, can be efficiently collected.

In the radiation CT system SYS3, at first, the first projection-data collector 11 collects the cone-beam projection data DP1 in the initial angle range from 0° to 90°.

Next, the second projection-data collector 12 collects the cone-beam projection data DP1 in an angle range from 90° to 180° by imaging the subject W in a state where the subject W is rotated by 90° by its corresponding inter-device conveyance device 81.

Next, the third projection-data collector 13 collects the cone-beam projection data DP1 in an angle range from 180° to 270° by imaging the subject W in a state where the subject W is further rotated by 90° by its corresponding inter-device conveyance device 81.

Finally, the fourth projection-data collector 14 collects the cone-beam projection data DP1 in an angle range from 270° to 360° by imaging the subject W in a state where the subject W is further rotated by 90° by its corresponding inter-device conveyance device 81.

The parallel-beam projection data converter 52 acquires the parallel-beam projection data DP2 based on the cone-beam projection data DP1 over the total angle range of 360°.

In this manner, the radiation CT system SYS3 is capable of performing reconstruction processing based on the parallel-beam projection data DP2 collected and converted in a full-scan angle range of 360°.

### Other Embodiments

Although embodiments of the present teaching have been described above, these embodiments are merely examples for implementing the present teaching. Therefore, the present teaching is not limited to the above-described embodiments, and various modifications may be made to the above embodiments as appropriate without departing from the subject matter of the present teaching.

In each of the above embodiments, the controller 50 of the radiation CT devices 1, 2, and 3 implements various functions by executing a program. That is, the controller 50 is implemented by software. However, the present teaching is not limited to this configuration, and the controller may alternatively be implemented by hardware, such as a dedicated integrated circuit. Further, the program may be stored in a non-transitory, tangible computer-readable storage medium. The storage medium may constitute part of the storage of the radiation CT device. Further, the program may also be supplied to the radiation CT device via arbitrary wired or wireless transmission medium.

In each of the above embodiments, the radiation source 21 includes a micro-focus X-ray tube having a focal spot size of several micrometers to several tens of micrometers. However, the radiation source may have a focal spot size larger than the micrometer order. Moreover, the radiation source may also emit gamma rays, neutrons, or the like.

In each of the above embodiments, the height direction Z of the radiation CT devices 1, 2, and 3 is, for example, a vertical direction. However, the height direction of the radiation CT device may be a horizontal direction, or may be a direction different from the up-down direction or the horizontal direction.

In Embodiments 3 to 6, the radiation CT device 3 and the radiation CT systems SYS1 to SYS3 include the parallel-beam projection data converter 52. However, the radiation CT device and the radiation CT system do not necessarily have to include the parallel-beam projection data converter. The radiation CT device and the radiation CT system may reconstruct an image based on the cone-beam projection data.

In each of the above embodiments, although not specifically described, the radiation CT device may include a preprocessing section that performs preprocessing on the projection data collected by the imaging controller. As preprocessing, the preprocessing section may perform image processing such as offset correction (dark correction), logarithmic transformation, gain correction (flat-field correction), and beam-hardening correction on the projection data. The parallel-beam projection data converter may convert the projection data, which has been preprocessed by the preprocessing section, into a parallel beam.

In Embodiments 4 to 6, although not specifically described, when projection data over an angle range of 180° or 360° is collected up to the N-th data collector, the imaging controller of the (N+1)-th data collector (where N = 1 in Embodiments 4 and 5, and N = 1, 2, or 3 in Embodiment 6) may collect the cone-beam projection data by imaging the subject in a state where the subject has been relatively moved by an amount corresponding to a half channel in at least one of the channel direction or the height direction, relative to the imaging performed in the N-th data collector.

According to the above configuration, the spatial resolution of the tomographic image or three-dimensional data reconstructed from the projection data can be improved in at least one of the channel direction and the height direction. As a result, a tomographic image of higher accuracy can be obtained.

In each of the above embodiments, the radiation CT devices 1, 2, and 3 store the cone-beam projection data DP1, the parallel-beam projection data DP2, and the tomographic image TG1 in the storage 30. However, the radiation CT device may upload various types of data to an external server connected via a communication network.

In each of the above embodiments, the detection surface configured in a two-dimensional array in the radiation detector 22 is, for example, orthogonal to the optical axis A. However, the detection surface of the radiation detector does not necessarily have to be orthogonal to the optical axis. The detection surface of the radiation detector may intersect the optical axis.

### Industrial Applicability

The present teaching is applicable to a radiation CT device and a radiation CT system configured to acquire a tomographic image of a subject by irradiating the subject with radiation.

### Reference Signs List

1, 2, 3: radiation CT device

11, 12, 13, 14: projection-data collector

21: radiation source

22: radiation detector

23: moving device

71: imaging controller

51: cone-beam projection data collector

52: parallel-beam projection data converter

53: reconstructor

531: reconstruction function convolution section

54: measurer

55: determiner

81: inter-device conveyance device

DP1: cone-beam projection data

DP2: parallel-beam projection data

SYS1, SYS2, SYS3: radiation CT system

TG1: tomographic image

W: subject

What is claimed is:

1. A radiation CT device configured to reconstruct a tomographic image based on projection data acquired by irradiating a subject with radiation,
the radiation CT device comprising:
a radiation source configured to emit cone-beam radiation that spreads three-dimensionally along an optical axis direction;
a radiation detector positioned on one side of the optical axis direction with respect to the radiation source, the radiation detector having channels for detecting the radiation, the channels being arranged in a two-dimensional array;
a moving device configured to pass the subject through the radiation by moving the subject relative to the radiation source and the radiation detector in a movement direction intersecting the optical axis direction;
a cone-beam projection data collector configured to collect cone-beam projection data, which is acquired by projecting the cone-beam radiation onto the radiation detector, at respective positions in the movement direction, by detecting, with the radiation detector, the radiation emitted from the radiation source onto the subject that is relatively moved in the movement direction by the moving device; and
a reconstructor configured to reconstruct a tomographic image or three-dimensional data based on the cone-beam projection data.

2. The radiation CT device according to claim 1, wherein
the reconstructor includes a parallel-beam projection data converter configured to acquire parallel-beam projection data corresponding to projection of a parallel beam through the subject, based on the collected cone-beam projection data, and
the reconstructor reconstructs a tomographic image based on the parallel-beam projection data.

3. The radiation CT device according to claim 2, wherein
the reconstructor includes a reconstruction function convolution section configured to suppress artifacts occurring in the tomographic image when a radiation angle range of the radiation source over which the parallel-beam projection data is acquired is less than 180°.

4. The radiation CT device according to claim 1, further comprising:
a measurer configured to measure a dimension of a target object in the tomographic image; and
a determiner configured to determine whether the dimension is within a predetermined range.

5. A radiation CT system, comprising:
a plurality of projection-data collectors configured to collect projection data acquired by irradiating a subject with radiation; and
a reconstructor configured to reconstruct a tomographic image based on the projection data collected by the projection-data collectors,
wherein each of the plurality of projection-data collectors comprises:
a radiation source configured to emit cone-beam radiation that spreads three-dimensionally along an optical axis direction;
a radiation detector positioned on one side of the optical axis direction with respect to the radiation source, the radiation detector having channels for detecting the radiation, the channels being arranged in a two-dimensional array;
a moving device configured to pass the subject through the radiation by moving the subject relative to the radiation source and the radiation detector in a movement direction intersecting the optical axis direction; and
an imaging controller configured to collect cone-beam projection data, which is acquired by projecting the cone-beam radiation onto the radiation detector, at respective positions in the movement direction, by detecting, with the radiation detector, the radiation emitted from the radiation source onto the subject that is relatively moved in the movement direction by the moving device,
wherein the imaging controller of each of the plurality of projection-data collectors performs imaging of the subject while changing a relative angle of the subject with respect to the radiation source and the radiation detector so that projection angles with respect to the subject correspond to continuous imaging directions, thereby collecting the cone-beam projection data such that a total angle range in the movement direction of the radiation source becomes 180° or more,
and wherein the reconstructor reconstructs a tomographic image or three-dimensional data based on the cone-beam projection data collected at each of the relative angles of the subject.

6. The radiation CT system according to claim 5, further comprising:
an inter-device conveyance device configured to convey the subject from a terminal end of the moving device of an N-th projection-data collector in the plurality of projection-data collectors to a starting end of the moving device of an (N+1)-th projection-data collector in the plurality of projection-data collectors,
wherein the inter-device conveyance device conveys the subject conveyed from the terminal end of the moving device of the N-th projection-data collector to the starting end of the moving device of the (N+1)-th projection-data collector in a state where the subject is rotated, relative to the radiation source and the radiation detector, by an amount corresponding to an angle range of the radiation source of the N-th projection-data collector.

7. The radiation CT system according to claim 5, wherein,
when projection data over an angle range of 180 degrees or 360 degrees is collected up to an N-th projection-data collector, the imaging controller of an (N+1)-th projection-data collector in the plurality of projection-data collectors collects the cone-beam projection data by imaging the subject in a state where the subject is relatively moved by an amount corresponding to a half channel in at least one of the channel direction and the height direction relative to imaging performed in the N-th projection-data collector in the plurality of projection-data collectors.
